(19) United States
(12) Patent Application Publication
(10) Pub. No.: US 2013/0085959 A1
(43) Pub. Date: Apr. 4, 2013

(54) APPARATUS FOR PRESENTING TASK PROCEDURES OF INDUSTRIAL PLANT ASSETS

(71) Applicant: Jinsong Qian, Singapore (SG)

(72) Inventor: Jinsong Qian, Singapore (SG)

(73) Assignee: YOKOGAWA ELECTRIC CORPORATION, Tokyo (JP)

(21) Appl. No.: 13/248,435

(22) Filed: Sep. 29, 2011

(51) Int. Cl. G06Q 10/06

(52) U.S. Cl. 705/343

(57) ABSTRACT

An apparatus for presenting task procedures of industrial plant assets to a field operator, the apparatus comprising an editing module accessed through a computer terminal, the editing module configured to allow a specialist to create at least one task procedure of at least one plant asset; an integration module configured to retrieve plant information provided by at least one other plant system; a server configured to store the at least one task procedure and the plant information; a presentation module configured to present the at least one task procedure and the plant information; and a mobile device configured to be operatively connectable to the server and to display to the field operator the at least one task procedure and the plant information presented by the presentation module.

### FIELD OF THE INVENTION

The invention relates to a method and apparatus for presenting task procedures in an industrial plant, and particularly, though not exclusively, relates to presenting task procedures for field operators in the industrial plant.

### BACKGROUND

Industrial plants typically comprise many pieces of equipment, commonly referred to as plant assets, for carrying out various operations in the plant. Many of the plant assets have specific operating procedures that need to be followed by field operators who operate them, in order for the assets to safely and effectively perform their functions. Normally, the plant asset operating procedures are presented to the field operators as task procedures comprising instructions that are printed, typed, or written on sheets of paper. There also exist digitized versions of such instructions presented in plain text format that are displayed on handheld devices used by the field operators.

When operating plant assets, besides referring to the plant asset operating procedures provided on paper or in digitized form, field operators often need to liaise with a control room in order to refer to other plant information that can be obtained only by other plant systems. For example, reference may be made of an asset management system of the industrial plant in order to have accurate knowledge of the current status and detailed parameters of a particular plant asset that is to be operated. Reference may be required of an operating system of the industrial plant in order to determine how the particular plant asset is presently functioning in relation to overall operations of the plant. In addition, reference may further be made of a distributed control system of the industrial plant for checking related control loop information of the particular plant asset. The field operator may also need to refer to an equipment diagnostics module to check any diagnostics results for the particular plant asset.

All the above references are made in view of ensuring that appropriate operations are carried out using the particular plant asset, based on relevant information obtained from the various reference sources, and according to specific task procedures presented on paper or digitally to the field operator. This often results in substantial rigidity in how operations for each plant asset can be performed, and limits efficiency in using and carrying out task procedures presented to the field operators. A field operator therefore must coordinate obtaining of appropriate plant information from various sources together with timely and accurate following of correct task procedures provided in hard or soft copy form, in order to operate a particular plant asset. This often requires the field operator to go from terminal to terminal in a control room in order to obtain the necessary plant information, as well as go to and from the control room and the plant asset in order to correctly carry out the task procedures.

### SUMMARY OF THE INVENTION

According to an exemplary aspect, there is provided an apparatus for presenting task procedures of industrial plant assets to a field operator, the apparatus comprising an editing module accessed through a computer terminal, the editing module configured to allow a specialist to create at least one task procedure of at least one plant asset; an integration module configured to retrieve plant information provided by at least one other plant system; a server configured to store the at least one task procedure and the plant information; a presentation module configured to present the at least one task procedure and the plant information; and a mobile device configured to be operatively connectable to the server and to display to the field operator the at least one task procedure and the plant information presented by the presentation module.

The integration module may further be configured to provide plant information for presentation by the presentation module where the at least one task procedure contains a link to the plant information.

The apparatus may further comprise a dynamic assembling module configured to automatically modify the at least one task procedure in response to the plant information retrieved by the integration module.

The at least one task procedure may comprise instructions created for presentation by the presentation module in at least one format selected from the group consisting of: plain text, rich text, tables, images, document files, audio recordings, video recordings, intranet links, internet links, and executable links to views of the plant information.

The editing module may further be configured to import instructions from an external document.

The editing module may further be configured to export created instructions.

The at least one other plant system may be selected from the group consisting of: an asset management system, a distributed control system, a diagnostics system, and a plant operating system.

The presentation module may further be configured to allow navigation between presentations of different task procedures and plant information.

The presentation module may further be configured to allow navigation within a presentation of the at least one task procedure.

The presentation module may further be configured to provide a search function configured to search within the at least one task procedure.

The editing module may further be configured to establish relationships within and between task procedures.

### BRIEF DESCRIPTION OF THE DRAWINGS

In order that the invention may be fully understood and readily put into practical effect there shall now be described by way of non-limitative example only exemplary embodiments of the present invention, the description being with reference to the accompanying illustrative drawings.

In the drawings:

FIG. 1 is an architectural diagram of an exemplary apparatus for presenting task procedures to a field operator; and

FIG. 2 is an exemplary architecture diagram of a task procedure for a plant asset.

### DETAILED DESCRIPTION OF THE EXEMPLARY EMBODIMENTS

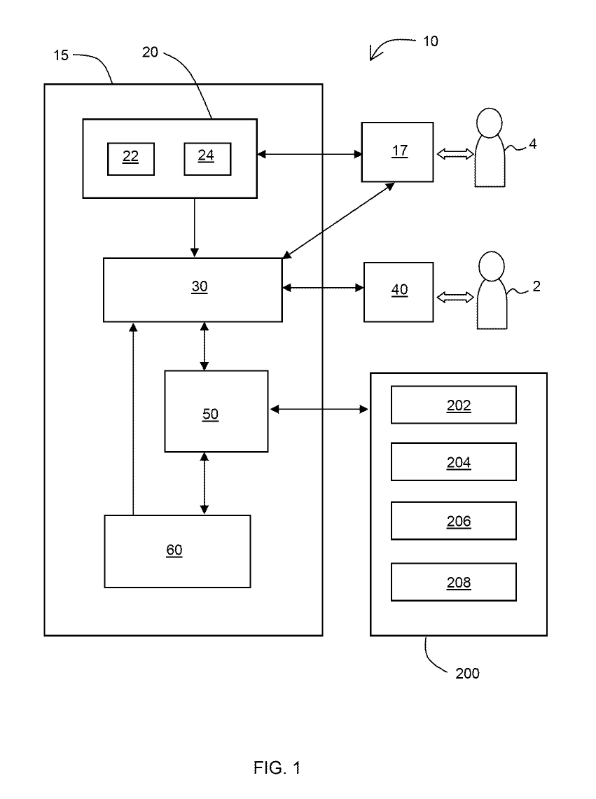

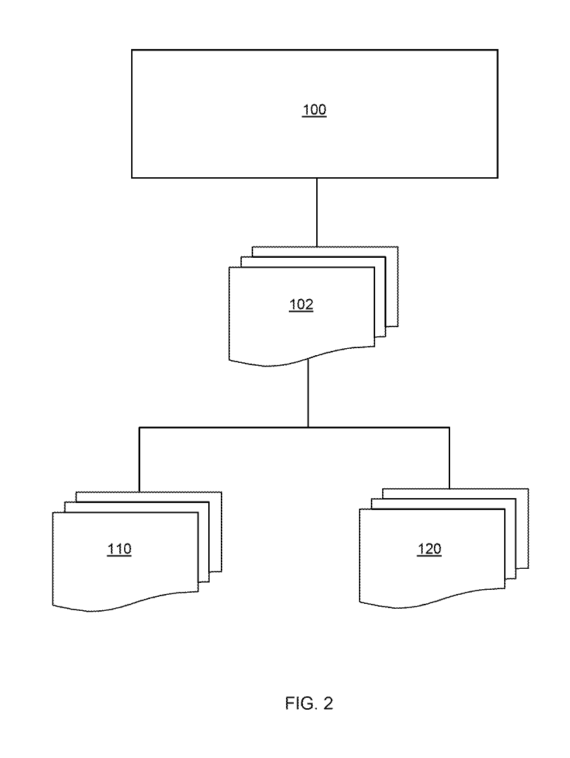

An exemplary apparatus 10 for presenting task procedures of industrial plant assets to a field operator 2 will be described with reference to FIGS. 1 and 2 below.

The apparatus 10 comprises an editing module 20 that is accessed through a computer terminal 17. The editing module 20 is configured to allow a specialist 4 to create task procedures 100 for the plant assets. The specialist 4 is typically someone who has specialist knowledge in how to operate that plant asset, and may have a supervisory capacity among the staff of the industrial plant. Created task procedures 100 are stored in a server 15. The editing module 20 is preferably provided in the server 15.

Each plant asset typically has its own one or more task procedures 100 to guide the field operator 2 in operating that plant asset. Each created task procedure 100 comprises instructions 102 that the editing module 20 is configured to create in the form of nodes 110, 120, using an editing tool 22 provided in the editing module 20. Using the same editing tool 22, the nodes 110, 120 are assembled to form the instructions 102, and the instructions 102 are then assembled to form the task procedure 100. The nodes may be static nodes 110 or active nodes 120. Each task procedure 100 can comprise a combination of a number of static 110 and active 120 nodes.

Instructions 102 that are in the form of static nodes 110 are created using the editing tool 22 for presentation by a presentation module 30 (described further below) in the form of plain text, rich text, tables, images, document files, audio recordings, video recordings, intranet links or internet links, and configured for activation by the field operator 2 where possible. An operation knowledge export/import assistant tool 24 is preferably provided in the editing module 20 in order to allow the specialist 4 to import instructions 102 from external documents directly, and to allow exporting of created instructions 102 to an external document or to a mobile device 40 that will be described below.

Instructions 102 that are in the form of active nodes 120 are created using the editing tool 22 for presentation by the presentation module 30 in the form of executable links to views of plant information retrieved from other plant systems 200. Such other plant systems 200 may include an asset management system 202, a distributed control system 204, a diagnostics system 206, and a plant operating system 208.

The editing tool 22 is preferably further configured to create or embed link for establishing inter-node relationships between various instructional nodes 110, 120 of each task procedure 100. Relationships may also be established using the editing tool 22 between different task procedures 100, for example, where they form part of a set of task procedures 100 for a particular plant asset. Relationships may further be established using the editing tool 22 between task procedures 100 for groups of related plant assets.

The presentation module 30 is configured to present created task procedures 100 to a user such as the specialist 4 and the field operator 2. The presentation module 30 is preferably provided in the server 15. The presentation module 30 includes a navigation function for the user 2,4 to move within and/or across instructions 102, and also move within and/or across task procedures 100. By selecting appropriate active nodes 120 presented by the presentation module 30, the user 2,4 can also navigate to views of plant information retrieved from the other plant systems 200. For example, the user 2,4 may navigate to an asset management view to check details or parameters of a plant asset, or navigate to a diagnostics view to check on historical, current or future health information and trend of the plant asset, or navigate to a distributed control view to check a control loop or real time information of the plant asset, or navigate to a plant operation view to monitor the condition of the plant asset or even perform operations interactively and/or automatically. The presentation module 30 is preferably also configured to provide a search function to allow a user to search within and/or across task procedures 100.

For the specialist 4, the presentation module 30 is preferably accessed and viewed through the same computer terminal 17. For the field operator 2, the mobile device 40 mentioned above is provided that comprises a screen to display the task procedures 100 presented by the presentation module 30. The mobile device 40 is preferably a hand-held device that may be carried around by the field operator 2 to different plant assets so that the field operator 2 can call up and refer to specific task procedures 100 displayed by the mobile device 40 when operating specific plant assets.

The mobile device 40 is configured to be operatively connectable to the server 15. Connection of the mobile device 40 to the server 15 is preferably achieved by periodic placement of the mobile device 40 in a synchronizing station provided in the industrial plant at a convenient location for the field operator 2 moving among the plant assets. The synchronizing station is connected to the server 15 by appropriate cabling. Placing the mobile device 40 in the synchronizing station allows synchronization of the task procedures 100 that can be displayed by the mobile device 40 with the task procedures 100 stored in the server 15. Alternatively, the mobile device 40 may be synchronised with the server 15 by means of a wireless connection.

An integration module 50 is provided that is configured to retrieve the plant information from the other plant systems 200. Retrieval of such plant information may be accomplished by periodically polling the other plant systems 200, subscribing to information published by the other plant systems 200, or by making ad hoc requests for the plant information. The server 15 is configured to store the retrieved plant information. The integration module 50 is also configured to provide the retrieved plant information for presentation by the presentation module 30 where the task procedure 100 contains an active node 120 linking to such plant information. The active nodes 120 in the created task procedures 100 thus link to views of the retrieved plant information of the other plant systems 200 that are provided to the presentation module 30 by the integration module 50.

The apparatus 10 preferably also comprises a dynamic assembling module 60 that is configured to automatically modify the created task procedures 100 in response to the plant information retrieved by the integration module 50 from the other plant systems 200. This is to allow on-the-fly and automatic modification of the task procedures 100 based on current conditions or status of a particular plant asset, without requiring editing of the task procedure 100 by the specialist 4. At the same time, the dynamic assembling module 60 is also configured to provide help information on task procedures 100 to the field operator 2, according to retrieved and presented plant information on a particular asset in a real-time way.

For example, if the plant information is a notification of a failure condition of a particular plant asset, the task procedure 100 presented by the presentation module 30 could be automatically modified by the dynamic assembling module 60 such that in place of or in addition to instructions 102 intended for normal operation of the plant asset, a special set of instructions 102 are presented to the user 2, 4 that would be suitable for taking corrective action on the failed plant asset.

Provided with the apparatus 10, the specialist 4 is therefore able to create task procedures 100 for various plant assets that can be viewed and referred to by a field operator 2 located at the industrial plant among the plant assets. The task procedures 100 contain not only lines of text, but are presented to the field operator 2 in a layered structure, with access to views of plant information from other plant systems 200. The created task procedures 100 also can have appropriate relationships established between instructions 102, between other task procedures 100 and even between numerous plant assets. Using the apparatus 10, the field operator 2 is provided with a comprehensive view of plant assets' condition, diagnostics, control, operations, and task procedures all in a single mobile device 40. This greatly streamlines the work of the field operator 2, who no longer has to go from terminal to terminal in a control room in order to obtain the necessary plant information for reference and then go to the plant asset in order to correctly carry out the operational instructions provided on a piece of paper or in softcopy form.

Whilst there has been described in the foregoing description exemplary embodiments of the present invention, it will be understood by those skilled in the technology concerned that many variations in details of design, construction and/or operation may be made without departing from the present invention.

1. An apparatus for presenting task procedures of industrial plant assets to a field operator, the apparatus comprising:
an editing module accessed through a computer terminal, the editing module configured to allow a specialist to create at least one task procedure of at least one plant asset;
an integration module configured to retrieve plant information provided by at least one other plant system;
a server configured to store the at least one task procedure and the plant information;
a presentation module configured to present the at least one task procedure and the plant information; and
a mobile device configured to be operatively connectable to the server and to display to the field operator the at least one task procedure and the plant information presented by the presentation module.

2. The apparatus of claim 1, wherein the integration module is further configured to provide plant information for presentation by the presentation module where the at least one task procedure contains a link to the plant information.

3. The apparatus of claim 1, further comprising a dynamic assembling module configured to automatically modify the at least one task procedure in response to the plant information retrieved by the integration module.

4. The apparatus of claim 1, wherein the at least one task procedure comprises instructions created for presentation by the presentation module in at least one format selected from the group consisting of plain text, rich text, tables, images, document files, audio recordings, video recordings, intranet links, internet links, and executable links to views of the plant information.

5. The apparatus of claim 1, wherein the editing module is further configured to import instructions from an external document.

6. The apparatus of claim 1, wherein the editing module is further configured to export created instructions.

7. The apparatus of claim 1, wherein the at least one other plant system is selected from the group consisting of: an asset management system, a distributed control system, a diagnostics system, and a plant operating system.

8. The apparatus of claim 1, wherein the presentation module is further configured to allow navigation between presentations of different task procedures and plant information.

9. The apparatus of claim 1, wherein the presentation module is further configured to allow navigation within a presentation of the at least one task procedure.

10. The apparatus of claim 1, wherein the presentation module is further configured to provide a search function configured to search within the at least one task procedure.

11. The apparatus of claim 1, wherein the editing module is further configured to establish relationships within and between task procedures.
